(19) United States
(12) Patent Application Publication
(10) Pub. No.: US 2015/0062116 A1
(43) Pub. Date: Mar. 5, 2015

(54) SYSTEMS AND METHODS FOR RAPIDLY GENERATING A 3-D MODEL OF A USER

(71) Applicant: 1-800 Contacts, Inc., Draper, UT (US)

(72) Inventor: Jonathan Coon, Austin, TX (US)

(73) Assignee: 1-800 Contacts, Inc., Draper, UT (US)

(21) Appl. No.: 14/015,816

(22) Filed: Aug. 30, 2013

(51) Int. Cl. G06T 15/10

(52) U.S. Cl. CPC G06T 15/10
USPC 345/419

(57) ABSTRACT

A computer-implemented method for generating a three-dimensional (3-D) model of a user. A first set of images are captured. Prior to capturing a second set of images the first set of images are processed using a 3-D modeling process, resulting in 3-D data and scaled data derived from the first set of images. The second set of images are captured after processing the first set of images. A second 3-D model of the user is generated using the second set of images of the user and the 3-D data derived from processing the first set of images. A feature of the user is tracked in real time based at least in part on the 3-D data derived from processing the first set of images.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computers have opened up an entire industry of internet shopping. In many ways, online shopping has changed the way consumers purchase products. For example, a consumer may want to know what they will look like in and/or with a product. On the webpage of a certain product, a photograph of a model with the particular product may be shown. However, users may want to see more accurate depictions of themselves in relation to various products.

### SUMMARY

According to at least one embodiment, a computer-implemented method for generating a three-dimensional (3-D) model of a user is described. A plurality of images of a user may be captured. A 3-D model of the user may be generated using the captured plurality of images of the user and 3-D data derived from processing a previously captured plurality of images of the user.

In one embodiment, a feature of the user may be tracked in real time based at least in part on the 3-D data derived from processing the previously captured plurality of images. The previously captured plurality of images may be captured. The previously captured plurality of images may be processed prior to capturing the plurality of images. In one embodiment, scaling data may be derived from a scaling image of the user to scale the 3-D data. The scaling image of the user may be captured in conjunction with the capturing of the previously captured plurality of images.

The 3-D model of the user may be generated using the scaling data derived from the scaling image of the user. Prior to capturing the plurality of images of the user, a 3-D modeling process may be performed on the previously captured plurality of images and the scaling image. Results of processing the previously captured plurality of images may be received. The results of processing the previously captured plurality of images may include the 3-D data. Results of processing the scaling image may be received. The results of processing the scaling image may include the scaling data. Prior to capturing the plurality of images of the user, a previous 3-D model of the user may be generated using the 3-D data derived from processing the previously captured plurality of images. The previous 3-D model of the user may be scaled using the scaling data derived from a scaling image of the user.

A computing device configured to generate a three-dimensional (3-D) model of a user is also described. The device may include a processor and memory in electronic communication with the processor. The memory may store instructions that are executable by the processor to capture a plurality of images of a user and to generate a 3-D model of the user using the captured plurality of images of the user and 3-D data derived from processing a previously captured plurality of images of the user.

A computer-program product to generate a three-dimensional (3-D) model of a user is also described. The computer-program product may include a non-transitory computer-readable medium that stores instructions. The instructions may be executable by a processor to capture a plurality of images of a user and to generate a 3-D model of the user using the captured plurality of images of the user and 3-D data derived from processing a previously captured plurality of images of the user.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating another embodiment of an environment in which the present systems and methods may be implemented;

FIG. 3 is a block diagram illustrating one example of a model generator;

FIG. 4 illustrates an example arrangement for capturing an image of a user;

FIG. 5 is a diagram illustrating an example of a device for capturing an image of a user;

FIG. 6 illustrates an example arrangement of a virtual 3-D space including a depiction of a 3-D model of a user;

FIG. 7 is a flow diagram illustrating one embodiment of a method for generating a 3-D model of a user;

FIG. 8 is a flow diagram illustrating one embodiment of a method for tracking a feature of the user in real-time;

FIG. 9 is a flow diagram illustrating one embodiment of a method for generating a 3-D model from previously captured images; and

FIG. 10 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to the virtually trying-on of products. Three-dimensional (3-D) computer graphics are graphics that use a 3-D representation of geometric data that is stored in the computer for the purposes of performing calculations and rendering two-dimensional (2-D) images. Such images may be stored for viewing later or displayed in real-time. A 3-D space may include a mathematical representation of a 3-D surface of an object. A 3-D model may be contained within a graphical data file. A 3-D model may represent a 3-D object using a collection of points in 3-D space, connected by various geometric entities such as triangles, lines, curved surfaces, etc. Being a collection of data (points and other information), 3-D models may be created by hand, algorithmically (procedural modeling), or scanned such as with a laser scanner. A 3-D model may be displayed visually as a two-dimensional image through a process called 3-D rendering, or used in non-graphical computer simulations and calculations. In some cases, the 3-D model may be physically created using a 3-D printing device.

A device may capture an image of a user and generate a 3-D model of the user from the image. A 3-D polygon mesh of an object may be placed in relation to the 3-D model of the user to create a 3-D virtual depiction of the user wearing the object (e.g., a pair of glasses, a hat, a shirt, a belt, etc.). This 3-D scene may then be rendered into a 2-D image to provide the user a virtual depiction of the user in relation to the object. Although some of the examples used herein describe articles of clothing, such as a virtual try-on pair of glasses, it is understood that the systems and methods described herein may be used to virtually try-on a wide variety of products. Examples of such products may include glasses, clothing, footwear, jewelry, accessories, hair styles, etc.

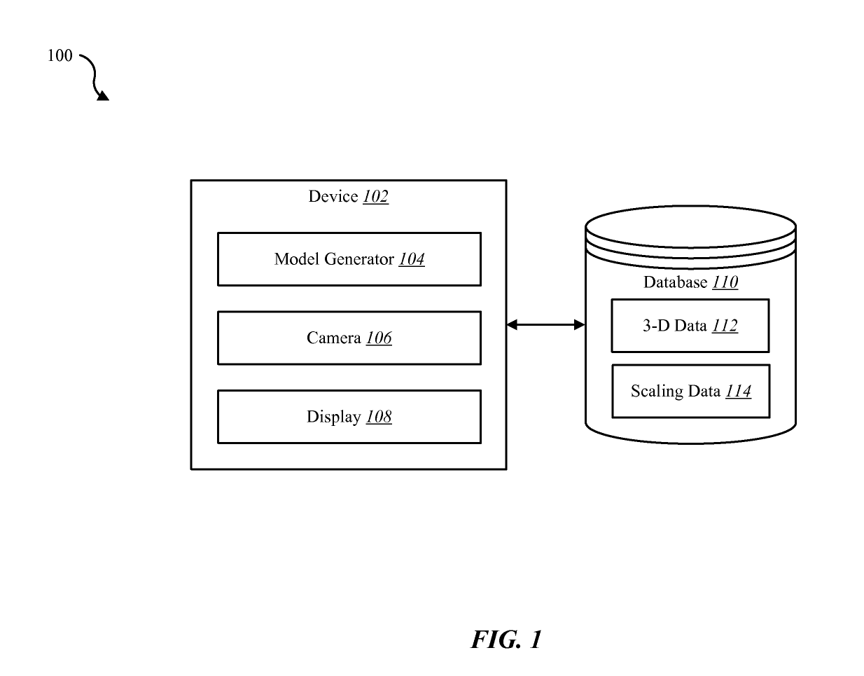

FIG. 1 is a block diagram illustrating one embodiment of an environment 100 in which the present systems and methods may be implemented. In some embodiments, the systems and methods described herein may be performed on a single device (e.g., device 102). For example, a model generator 104 may be located on device 102. Examples of device 102 include mobile devices, smart phones, personal computing devices, computers, servers, etc.

In some configurations, device 102 may include model generator 104, camera 106, and display 108. In one example, device 102 may be coupled to a database 110. In one embodiment, database 110 may be internal to device 102. In another embodiment, database 110 may be external to device 102. In some configurations, database 110 may include 3-D data 112 and scaling data 114.

In one embodiment, model generator 104 may enable a user to initiate a process to generate a 3-D model of the user. In some configurations, model generator 104 may obtain multiple images of the user. For example, model generator 104 may capture multiple images of a user via camera 106. For instance, model generator 104 may capture a video (e.g., a 5 second video) via camera 106. Alternatively, model generator 104 may capture one or more photographs via camera 106. In some configurations, model generator 104 may use 3-D data 112 and scaling data 114 to generate a 3-D representation of a user. For example, 3-D data 112 may include vertex coordinates of a polygon model of a user (e.g., a user's head, face, hand, etc.). Thus, model generator 104 may generate a 3-D model of a user using 3-D data 112 and scaling data 114. In some embodiments, 3-D data 112 may include a polygon model of an object. In some configurations, the scaling data 114 may define a visual aspect (e.g., pixel information) of the 3-D model of the object such as color, texture, shadow, or transparency.

In some configurations, model generator 104 may generate a first 3-D model of a user from a first plurality of images of the user. The first plurality of images may include at least one scaling image of the user. Model generator 104 may derive 3-D data by processing the first plurality of images. Model generator 104 may derive scaling data from the at least one scaling image of the user. A first 3-D model of the user may be generated, via model generator 104, using the derived 3-D data and scaling data. Model generator 104 may capture a second plurality of images of the user after processing the first plurality of images (e.g., deriving 3-D data and scaling data from the first plurality of images). A second 3-D model of the user may be generated, via model generator 104, using the second plurality of images and the 3-D data and scaling data derived from the first plurality of images.

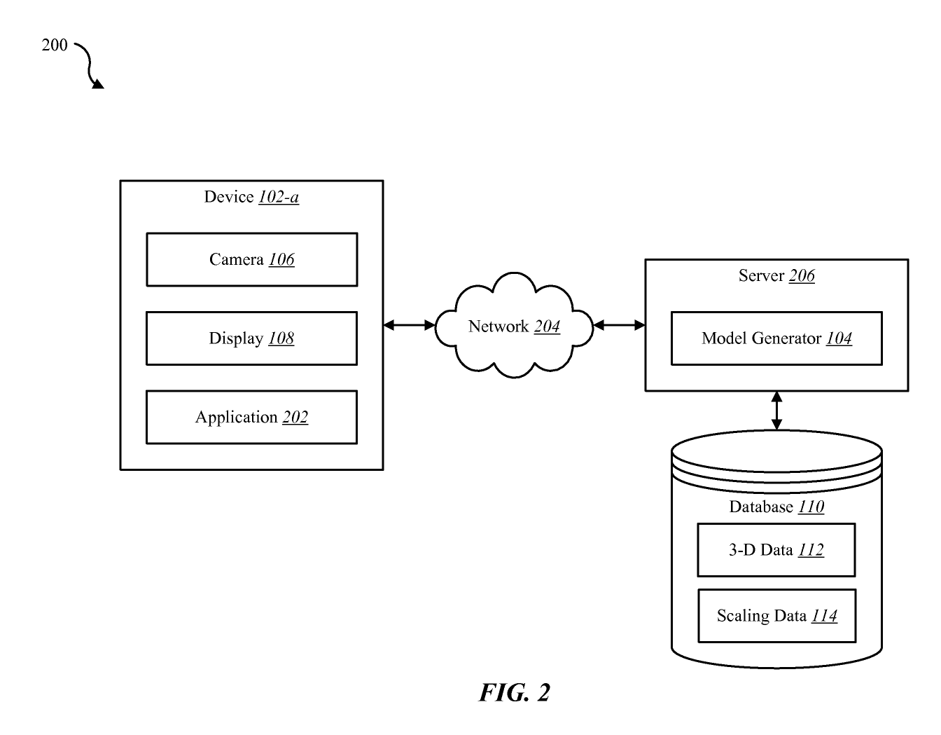

FIG. 2 is a block diagram illustrating another embodiment of an environment 200 in which the present systems and methods may be implemented. In some embodiments, a device 102-a may communicate with a server 206 via a network 204. Example of networks 204 include, local area networks (LAN), wide area networks (WAN), virtual private networks (VPN), wireless networks (using 802.11, for example), cellular networks (using 3G and/or LTE, for example), etc. In some configurations, the network 204 may include the internet. In some configurations, device 102-a may be one example of device 102 illustrated in FIG. 1. For example, device 102-a may include camera 106, display 108, and application 202. It is noted that in some embodiments, device 102-a may not include model generator 104. In some embodiments, both device 102-a and server 206 may include model generator 104 where at least a portion of the functions of model generator 104 are performed separately and/or concurrently on both device 102-a and server 206.

In some embodiments, server 206 may include model generator 104 and may be coupled to the database 110. For example, model generator 104 may access 3-D data 112 and scaling data 114 in database 110 via server 206. The database 110 may be internal or external to server 206.

In some configurations, the application 202 may capture multiple images via camera 106. For example, the application 202 may use camera 106 to capture a video. Upon capturing the multiple images, the application 202 may process the multiple images to generate 3-D data and/or scaling data. In some embodiments, the application 202 may transmit the multiple images to server 206. Additionally or alternatively, the application 202 may transmit to server 206 3-D data and scaling data, or at least one file associated with 3-D data and scaling data.

In some configurations, model generator 104 may process multiple images of a user to generate a 3-D model of the user. Model generator 104 may render a 3-D space that includes the 3-D model of the user and a 3-D polygon model of an object to render a virtual try-on 2-D image of the object and the user. The application 202 may output a display of the user to the display 108 while camera 106 captures an image of the user.

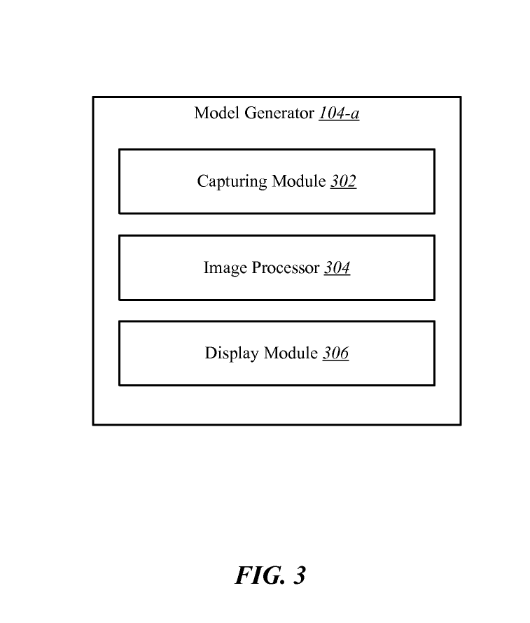

FIG. 3 is a block diagram illustrating one example of a model generator 104-a. Model generator 104-a may be one example of model generator 104 depicted in FIGS. 1 and/or 2. As depicted, model generator 104-a may include a capturing module 302, an image processor 304, and a display module 306.

In some configurations, the capturing module 302 may obtain a plurality of images of a user. In some embodiments, the capturing module 302 may activate camera 106 to capture at least one image of the user (e.g., a photograph). In some embodiments, the image processor 304 may process an image of the user captured by the capturing module 302. The image processor 304 may be configured to generate a 3-D model of the user from the processing of the image.

In one embodiment, capturing module 302 may capture a plurality of images of a user, which may include photographs and or video images. In some embodiments, capturing module 302 may track a feature of the user in real time based at least in part on 3-D data derived from a set of previously captured and previously processed images. Capturing module 302 may capture a video of the user. In one example, capturing module 302 may capture images of a user (e.g., photographs). Image processor 304 may track one or more features of the real-time images of the user based on previously derived 3-D data of the user based on detected correlations between features of the real-time images of the user and corresponding features of the 3-D data. Display module 306 may display the real-time images and/or tracked features on a display in real time.

In one example, capturing module 302 may capture a first plurality of images. The first plurality of images may be processed prior to capturing a second plurality of images. In some cases, capturing module 302 may send the first plurality of images, including one or more scaling images, to a server for processing. Image processor 304 may process the plurality of images to generate 3-D data and/or scaling data. Model generator 104-a may receive the results of processing the first plurality of images and processing the one or more scaling images (e.g., 3-D data and/or scaling data).

In some embodiments, capturing module 302 may capture a second plurality of images subsequent to processing the first plurality of images. In one example, image processor 304 may generate a 3-D model of the user using the second plurality of images of the user in combination with the 3-D data derived from the first plurality of images of the user. Image processor 304 may detect an interest point in one or more of the second plurality of images and correlate the detected interest point with an interest point of the 3-D data. Image processor 304 may scale the 3-D model of the user using the scaling data derived from processing the one or more scaling images captured in conjunction with the capturing the first plurality of images. In some cases, image processor 304 may generate a first 3-D model of the user using the 3-D data derived from the first plurality of images, and generate a second 3-D model of the user using the second plurality of images and the same 3-D data derived from the first plurality of images. Display module 306 may display the first and/or second 3-D models on a display. In some embodiments, display module 306 may display

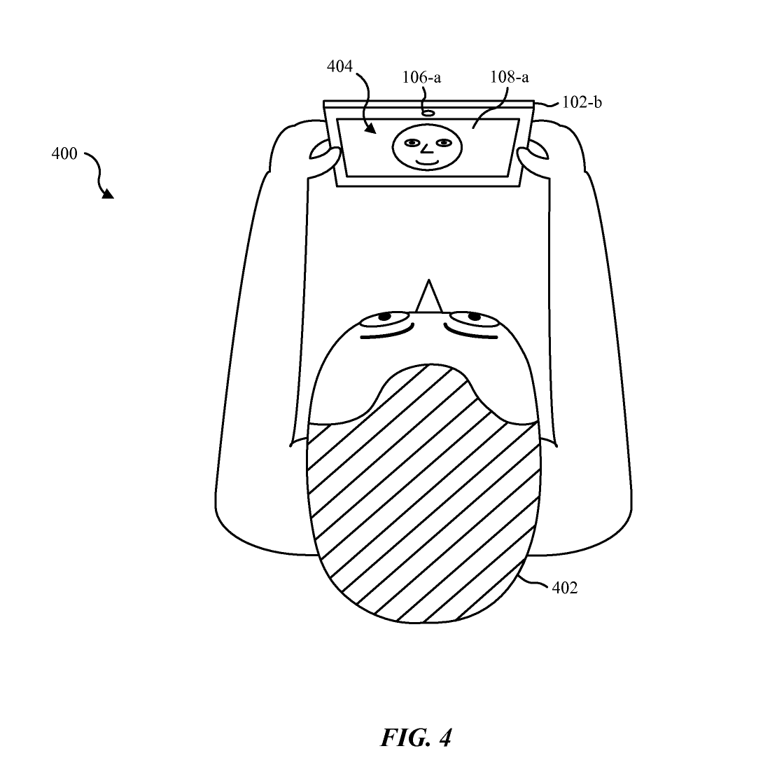

FIG. 4 illustrates an example arrangement 400 for capturing an image 404 of a user 402. In particular, the illustrated example arrangement 400 may include the user 402 holding a device 102-b. Device 102-b may include a camera 106-a and a display 108-a. Device 102-b, camera 106-a, and display 108-a may be examples of device 102, camera 106, and display 108 depicted in FIGS. 1 and/or 2.

In one example, the user 402 holds device 102-b at arm's length with camera 106-a activated. Camera 106-a may capture an image 404 of the user and the display 108-a may show the captured image 404 to the user 402 (e.g., a real-time feedback image of the user). In some configurations, camera 106-a may capture a video of the user 402. In some embodiments, the user may pan device 102-b around the user's face to allow camera 106-a to capture a video of the user from one side of the user's face to the other side of the user's face. Additionally, or alternatively, the user 402 may capture an image of other areas (e.g., arm, leg, torso, etc.).

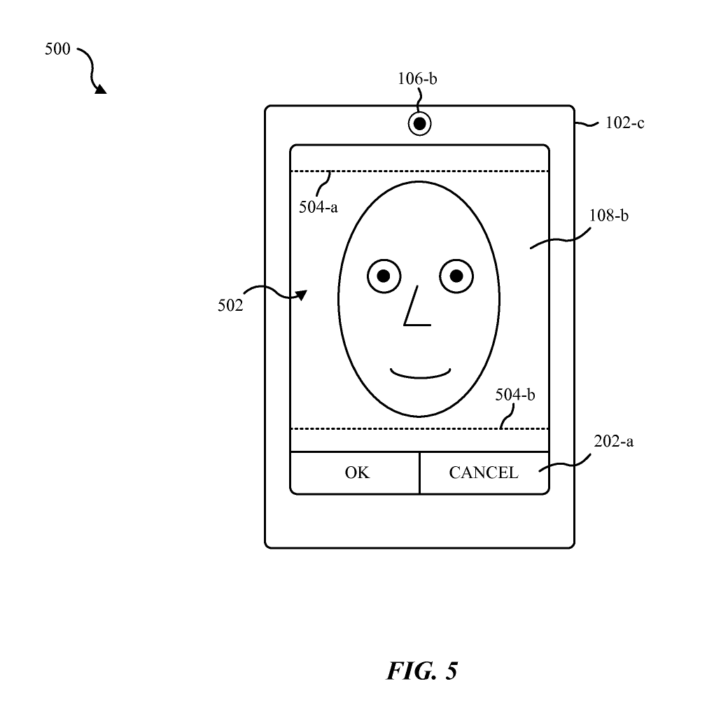

FIG. 5 is a diagram 500 illustrating an example of a device 102-c for capturing an image 502 of a user. Device 102-c may be one example of device 102 illustrated in FIGS. 1 and/or 2. As depicted, device 102-c may include a camera 106-b, a display 108-b, and an application 202-a. Camera 106-b, display 108-b, and application 202-a may each be an example of the respective camera 106, display 108, and application 202 illustrated in FIGS. 1 and/or 2.

In one embodiment, the user may operate device 102-c. For example, the application 202-a may allow the user to interact with and/or operate device 102-c. In one embodiment, the application 202-a may allow the user to capture an image 505 of the user. The display may show guidelines 504-a and 504-b to provide visual feedback to the user where to place the camera 106-b in relation to their face, etc. Application 202-a may display the captured image 502 on display 108-b. In some cases, the application 202-a may permit the user to accept or decline the image 502 that was captured. In some embodiments, camera 106-b captures real-time images of the user and display 108-b shows the captured images (e.g. image 502) in real-time. Model generator 104 may track a feature of the real-time images of the user (e.g., facial features such as eyes, nose, mouth, etc.) based on 3-D data of the user derived from a previously captured plurality of images.

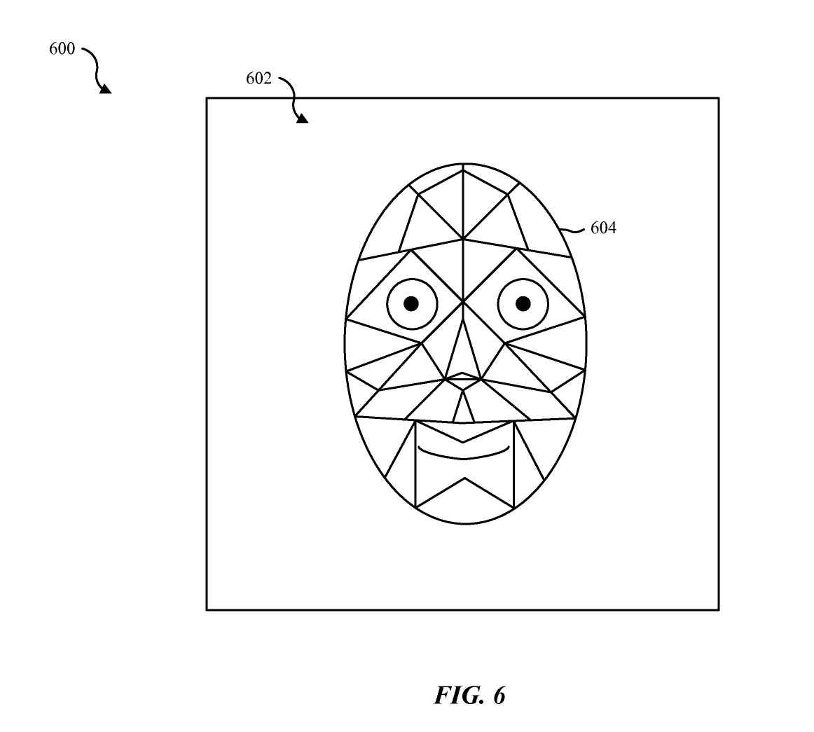

FIG. 6 illustrates an example arrangement 600 of a virtual 3-D space 602. As depicted, the 3-D space 602 of the example arrangement 600 may include a 3-D model of a user's head 604. In some embodiments, the 3-D model of the user's head 604 may include a polygon mesh model of the user's head, which may be stored in database 110 as 3-D data 112. The 3-D data of the 3-D model of the user may include 3-D polygon mesh elements such as vertices, edges, faces, polygons, surfaces, and the like. Additionally, or alternatively, the 3-D model of the user's head 604 may include at least one texture map, which may be stored in the database 110.

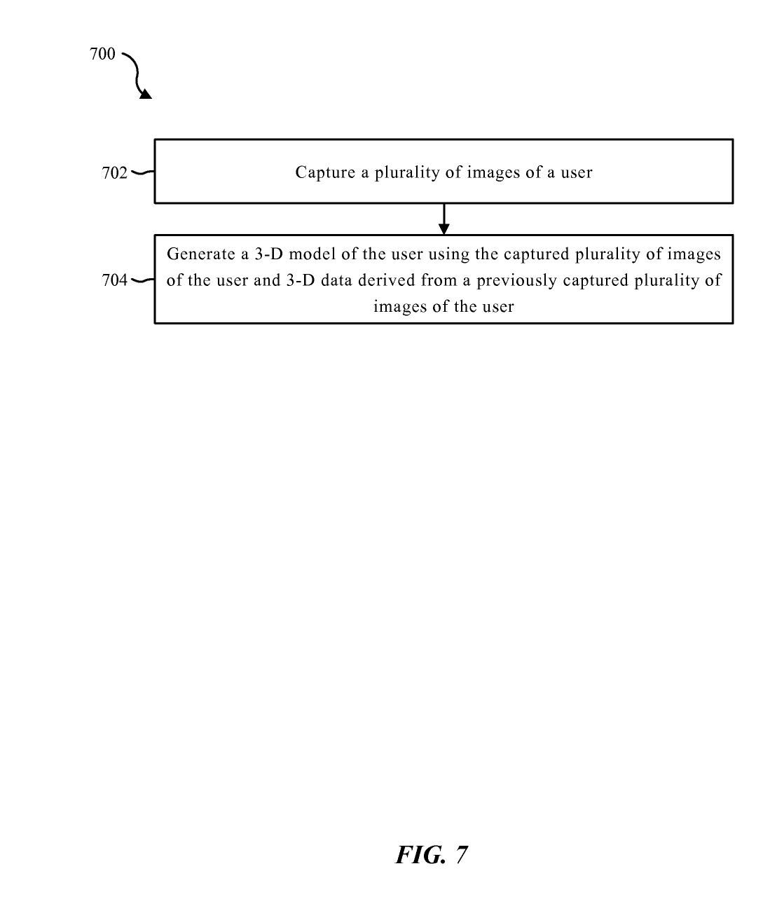

FIG. 7 is a flow diagram illustrating one embodiment of a method 700 for generating a 3-D model of a user. In some configurations, the method 700 may be implemented by model generator 104 illustrated in FIGS. 1, 2, and/or 3. In some configurations, the method 700 may be implemented by the application 202 illustrated in FIG. 2.

At block 702, a plurality of images of a user may be captured. At block 704, a 3-D model of the user may be generated using the captured plurality of images of the user and 3-D data derived from a previously captured plurality of images of the user.

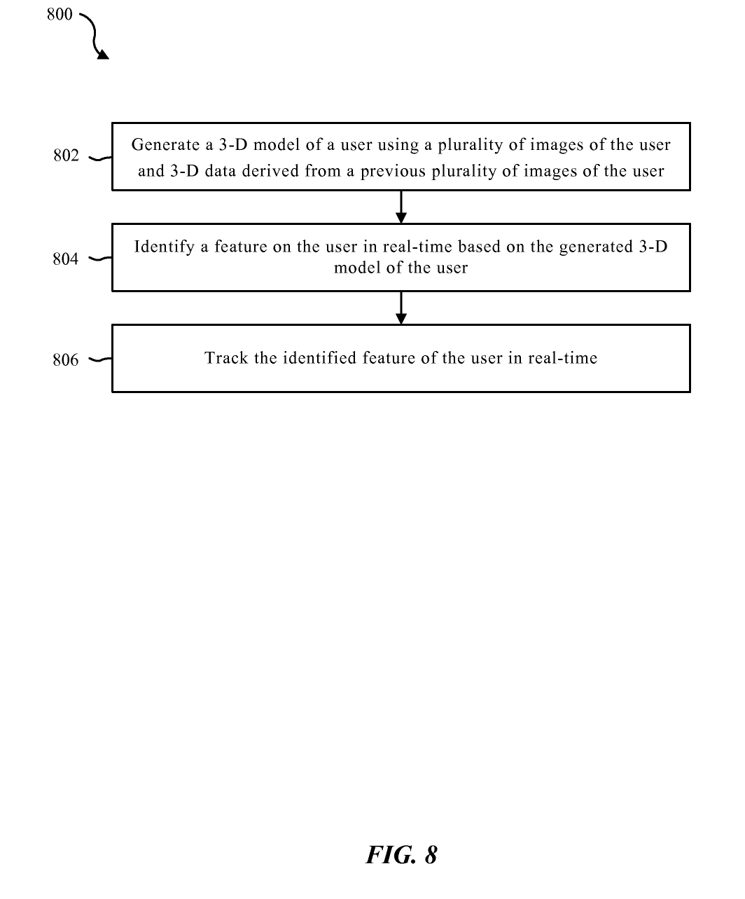

FIG. 8 is a flow diagram illustrating one embodiment of a method 800 for tracking a feature of the user in real-time. In some configurations, the method 800 may be implemented by model generator 104 illustrated in FIGS. 1, 2, and/or 3. In some configurations, the method 700 may be implemented by the application 202 illustrated in FIG. 2.

At block 802, a 3-D model of a user may be generated using a plurality of images of the user and 3-D data derived from a previous plurality of images of the user. At block 804, a feature on the user may be identified in real-time based on the generated 3-D model of the user. At block 806 the identified feature of the user may be tracked in real-time.

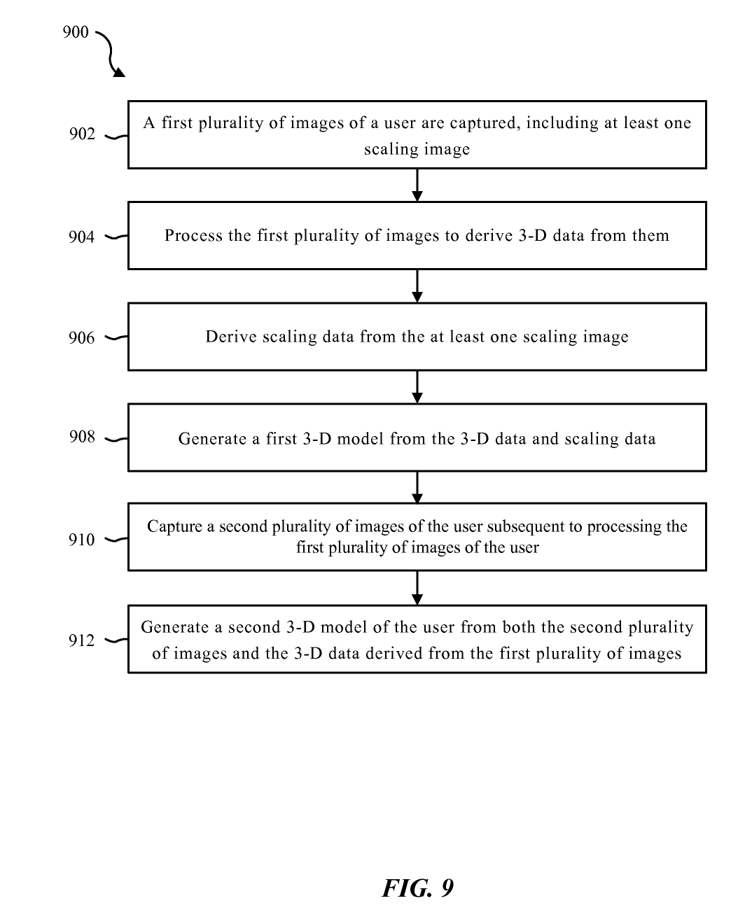

FIG. 9 is a flow diagram illustrating one embodiment of a method 900 for displaying a feedback image to a user. In some configurations, the method 900 may be implemented by model generator 104 illustrated in FIGS. 1, 2, and/or 3. In some configurations, the method 900 may be implemented by the application 202 illustrated in FIG. 2.

At block 902, a first plurality of images of a user may be captured, including at least one scaling image. At block 904, the first plurality of images may be processed in order to derive 3-D data from them. At block 906, scaling data may be derived from the at least one scaling image. At block 908, a first 3-D model may be generated from the 3-D data and scaling data. At block 910, a second plurality of images of the user may be captured subsequent to processing the first plurality of images of the user. At block 912, a second 3-D model of the user may be generated from both the second plurality of images and the 3-D data derived from the first plurality of images.

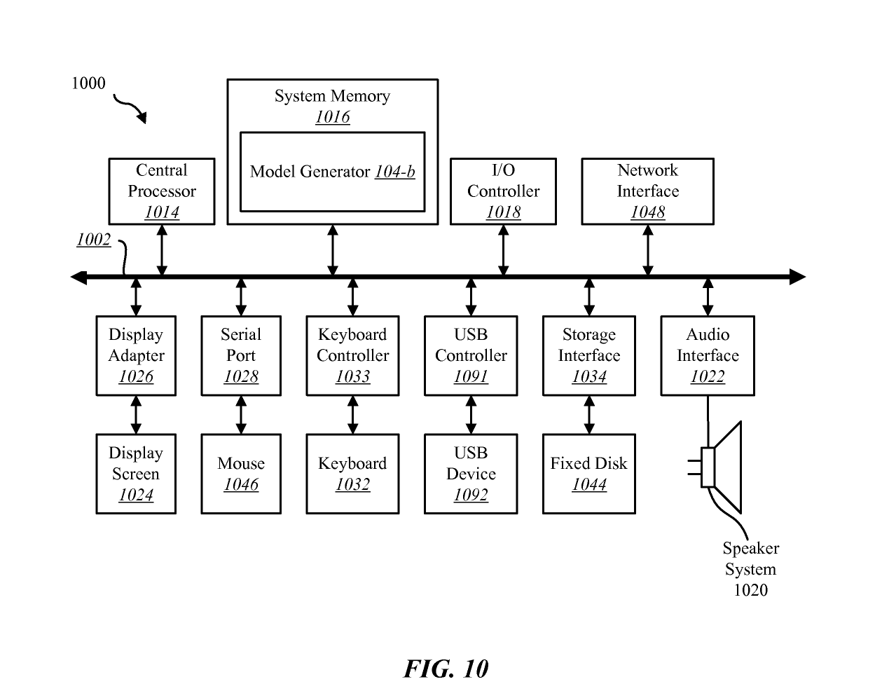

FIG. 10 depicts a block diagram of a computer system 1000 suitable for implementing the present systems and methods. Computer system 1010 includes a bus 1002 which interconnects major subsystems of computer system 1010, such as a central processor 1014, a system memory 1016 (typically RAM, but which may also include ROM, flash RAM, or the like), an input/output controller 1018, an external audio device, such as a speaker system 1020 via an audio output interface 1022, an external device, such as a display screen 1024 via display adapter 1026, an keyboard 1032 (interfaced with a keyboard controller 1033) (or other input device), multiple USB devices 1092 (interfaced with a USB controller 1091), and a storage interface 1034. Also included are a mouse 1046 (or other point-and-click device) and a network interface 1048 (coupled directly to bus 1002).

Bus 1002 allows data communication between central processor 1014 and system memory 1016, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the rendering module 104-b to implement the present systems and methods may be stored within the system memory 1016. Applications (e.g., application 202) resident with computer system 1010 are generally stored on and accessed via a non-transitory computer readable medium, such as a hard disk drive (e.g., fixed disk 1044) or other storage medium. Additionally, applications can be in the form of electronic signals modulated in accordance with the application and data communication technology when accessed via interface 1048.

Storage interface 1034, as with the other storage interfaces of computer system 1010, can connect to a standard computer readable medium for storage and/or retrieval of information, such as a fixed disk drive 1044. Fixed disk drive 1044 may be a part of computer system 1010 or may be separate and accessed through other interface systems. Network interface 1048 may provide a direct connection to a remote server via a direct network link to the Internet via a POP (point of presence). Network interface 1048 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., document scanners, digital cameras, and so on). Conversely, all of the devices shown in FIG. 10 need not be present to practice the present systems and methods. The devices and subsystems can be interconnected in different ways from that shown in FIG. 10. The operation of a computer system such as that shown in FIG. 10 is readily known in the art and is not discussed in detail in this application. Code to implement the present disclosure can be stored in a non-transitory computer-readable medium such as one or more of system memory 1016 or fixed disk 1044. The operating system provided on computer system 1010 may be iOS®, MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for generating a three-dimensional (3-D) model of a user, the method comprising:
capturing a plurality of images of a user; and
generating a 3-D model of the user using the captured plurality of images of the user and 3-D data derived from processing a previously captured plurality of images of the user.

2. The method of claim 1, further comprising:
tracking a feature of the user in real time based at least in part on the 3-D data derived from processing the previously captured plurality of images.

3. The method of claim 1, further comprising:
capturing the previously captured plurality of images, wherein the previously captured plurality of images are processed prior to capturing the plurality of images.

4. The method of claim 3, further comprising:
deriving scaling data to scale the 3-D data from a scaling image of the user, the scaling image of the user being captured in conjunction with the capturing of the previously captured plurality of images.

5. The method of claim 4, further comprising:
scaling the 3-D model of the user using the scaling data derived from the scaling image of the user.

6. The method of claim 4, further comprising:
prior to capturing the plurality of images of the user, performing a 3-D modeling process on the previously captured plurality of images and the scaling image.

7. The method of claim 6, further comprising:
receiving results of processing the previously captured plurality of images, the results of processing the previously captured plurality of images comprising the 3-D data; and
receiving results of processing the scaling image, the results of processing the scaling image comprising the scaling data.

8. The method of claim 1, further comprising:
prior to capturing the plurality of images of the user, generating a previous 3-D model of the user using the 3-D data derived from processing the previously captured plurality of images.

9. The method of claim 8, further comprising:
scaling the previous 3-D model of the user using scaling data derived from a scaling image of the user.

10. A computing device configured to generate a three-dimensional (3-D) model of a user, comprising:
a processor;
memory in electronic communication with the processor;
instructions stored in the memory, the instructions being executable by the processor to:
capture a plurality of images of a user; and
generate a 3-D model of the user using the captured plurality of images of the user and 3-D data derived from processing a previously captured plurality of images of the user.

11. The computing device of claim 10, wherein the instructions are executable by the processor to:
track a feature of the user in real time based at least in part on the 3-D data derived from the previously captured plurality of images.

12. The computing device of claim 10, wherein the instructions are executable by the processor to:
capture the previously captured plurality of images, wherein the previously captured plurality of images are processed prior to capturing the plurality of images.

13. The computing device of claim 12, wherein the instructions are executable by the processor to:
derive scaling data to scale the 3-D data from a scaling image of the user, the scaling image of the user being captured in conjunction with the capturing of the previously captured plurality of images.

14. The computing device of claim 13, wherein the instructions are executable by the processor to:
scale the 3-D model of the user using the scaling data derived from the scaling image of the user.

15. The computing device of claim 13, wherein the instructions are executable by the processor to:
prior to capturing the plurality of images of the user, perform a 3-D modeling process on the previously captured plurality of images and the scaling image.

16. The computing device of claim 15, wherein the instructions are executable by the processor to:
receive results of processing the previously captured plurality of images, the results of processing the previously captured plurality of images comprising the 3-D data; and
receive results of processing the scaling image, the results of processing the scaling image comprising the scaling data.

17. The computing device of claim 10, wherein the instructions are executable by the processor to:
prior to capturing the plurality of images of the user, generate a previous 3-D model of the user using the 3-D data derived from processing the previously captured plurality of images.

18. The computing device of claim 17, wherein the instructions are executable by the processor to:
scale the previous 3-D model of the user using scaling data derived from a scaling image of the user.

19. A computer-program product for generating, by a processor, a three-dimensional (3-D) model of a user, the computer-program product comprising a non-transitory computer-readable medium storing instructions thereon, the instructions being executable by the processor to:
capture a plurality of images of a user; and
generate a 3-D model of the user using the captured plurality of images of the user and 3-D data derived from processing a previously captured plurality of images of the user.

20. The computer-program product of claim 20, wherein the instructions are executable by the processor to:
track a feature of the user in real time based at least in part on the 3-D data derived from processing the previously captured plurality of images.
